(19) United States
(12) Patent Application Publication
(10) Pub. No.: US 2015/0326425 A1
(43) Pub. Date: Nov. 12, 2015

(54) RECORDING, ANALYZING, AND RESTORING NETWORK STATES IN SOFTWARE-DEFINED NETWORKS

(71) Applicant: NTT INNOVATION INSTITUTE, INC., East Palo Alto, CA (US)

(72) Inventors: Sriram Natarajan, Sunnyvale, CA (US); Eric Chen, Palo Alto, CA (US)

(73) Assignee: NTT INNOVATION INSTITUTE, INC., East Palo Alto, CA (US)

(21) Appl. No.: 14/275,593

(22) Filed: May 12, 2014

(51) Int. Cl. H04L 12/24

(52) U.S. Cl. CPC H04L 41/0654

(57) ABSTRACT

A system that includes a recorder that records information of a flow table of at least one network device in a network by capturing information regarding the flow table that is transmitted to and from the network device, wherein the network device receives and forwards incoming packet data over the network, and the flow table is used to determine how each incoming packet is handled by the network device; an analyzer that analyzes state changes in the network and manages a network state; and a restorer that, when a type of failure occurs in the network, recovers the network state by restoring at least a portion of the flow table using the recorded information of the flow table and based on the type of failure event that has occurred.

### BACKGROUND

1. Field

The disclosure herein generally relates to systems and methods for software-defined networks. In particular, systems and methods for recording, analyzing, and restoring a network state in software-defined networks are described.

2. Description of the Related Art

In a software-defined network (SDN) architecture, the control and data planes are decoupled, the network intelligence and state are logically centralized, and the underlying network infrastructure is set apart from the applications. As a result, enterprises and carriers can obtain programmability, automation, and network control. This enables them to build highly scalable, flexible networks that can readily adapt to changing business needs. A communication channel operates between the control and data planes of supported network devices.

The physical separation of data and control plane components make inter-communication of SDNs susceptible as a result of switch, component, or state failures. The communication channel between the controller and infrastructure layer is prone to disconnections, either due to session timeouts, echo request timeouts, or controller and/or hardware issues. Restoring a connection may require re-computation of the entire network state or possibly presenting stale information.

### SUMMARY

According an embodiment, there is provided a system that includes a recorder that records information of a flow table of at least one network device in a network by capturing information regarding the flow table that is transmitted to and from the network device, wherein the network device receives and forwards incoming packet data over the network, and the flow table is used to determine how each incoming packet is handled by the network device; an analyzer that analyzes state changes in the network and manages a network state; and a restorer that, when a type of failure occurs in the network, recovers the network state by restoring at least a portion of the flow table using the recorded information of the flow table and based on the type of failure event that has occurred.

According to another embodiment, there is provided a method, implemented by a system that includes a recorder, an analyzer, and a restorer, the method including: recording, by the recorder, information of a flow table of at least one network device in a network by capturing information regarding the flow table that is transmitted to and from the network device, wherein the network device receives and forwards incoming packet data over the network, and the flow table is used to determine how each incoming packet is handled by the network device; analyzing, by the analyzer, state changes in the network and manages a network state; and recovering, by the restorer, when a type of failure occurs in the network, the network state by restoring at least a portion of the flow table using the recorded information of the flow table and based on the type of failure event that has occurred.

According to another embodiment, there is provided a non-transitory computer-readable medium that stores a program, which when implemented by a computer, causes the computer to perform a method comprising: recording information of a flow table of at least one network device in a network by capturing information regarding the flow table that is transmitted to and from the network device, wherein the network device receives and forwards incoming packet data over the network, and the flow table is used to determine how each incoming packet is handled by the network device; analyzing state changes in the network and manages a network state; and recovering when a type of failure occurs in the network, the network state by restoring at least a portion of the flow table using the recorded information of the flow table and based on the type of failure event that has occurred.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A illustrates a software-defined network;

FIG. 1B is a snapshot of an alternative version of a flow table and header fields;

FIG. 2 illustrates a software-defined network and various failure mechanisms, according to embodiments;

FIG. 3 illustrates a software-defined network with a recorder, analyzer, and restorer component, according to embodiments;

FIG. 4 is a flow algorithm, according to embodiments;

FIG. 5 illustrates a flow table, according to embodiments;

FIG. 6 is a flow algorithm, according to embodiments;

FIG. 7 is a flow algorithm, according to embodiments;

FIG. 8 is a flow algorithm, according to embodiments;

FIG. 9 is a block diagram of a computing system, according to embodiments; and

FIG. 10 is a flow chart illustrating a method of tracking and recording network state changes, according to embodiments.

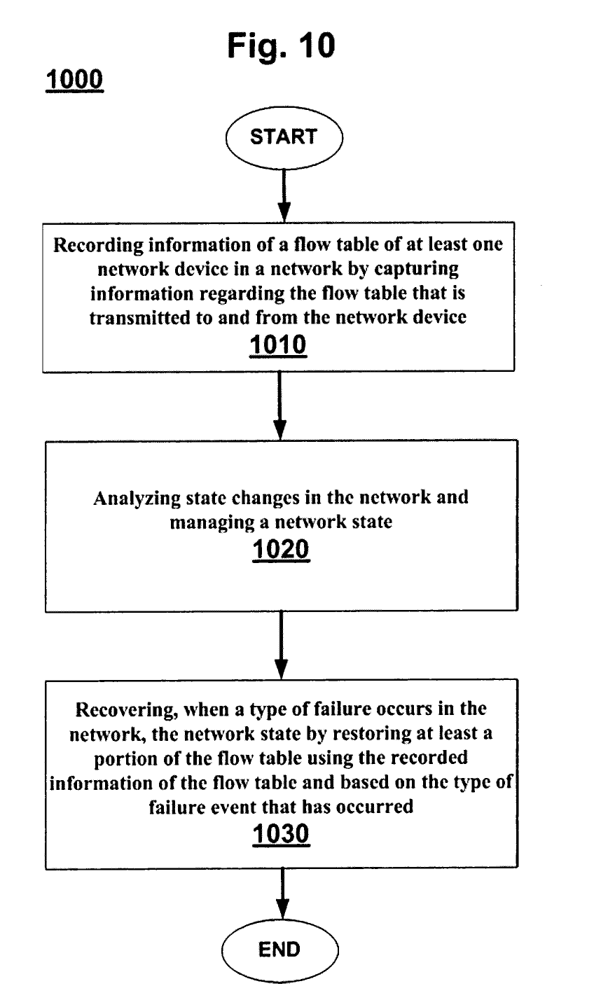

Like reference numerals designate identical or corresponding parts throughout the several views.

### DETAILED DESCRIPTION

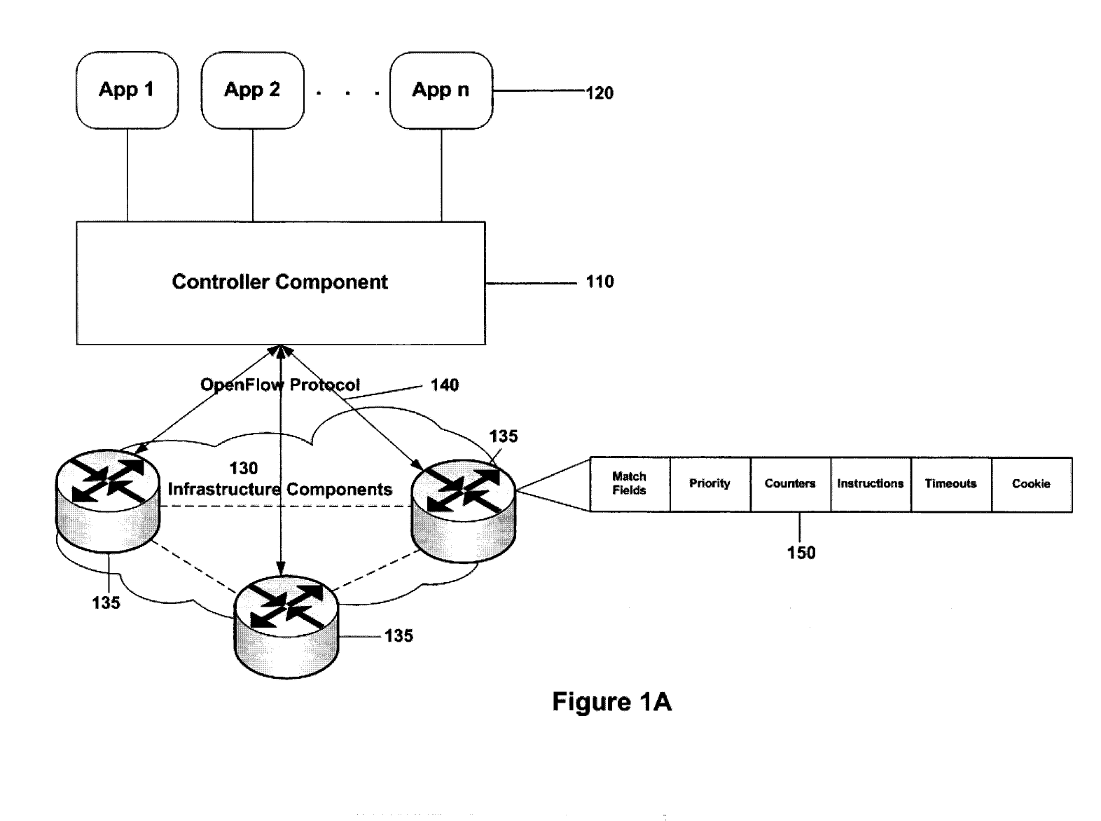

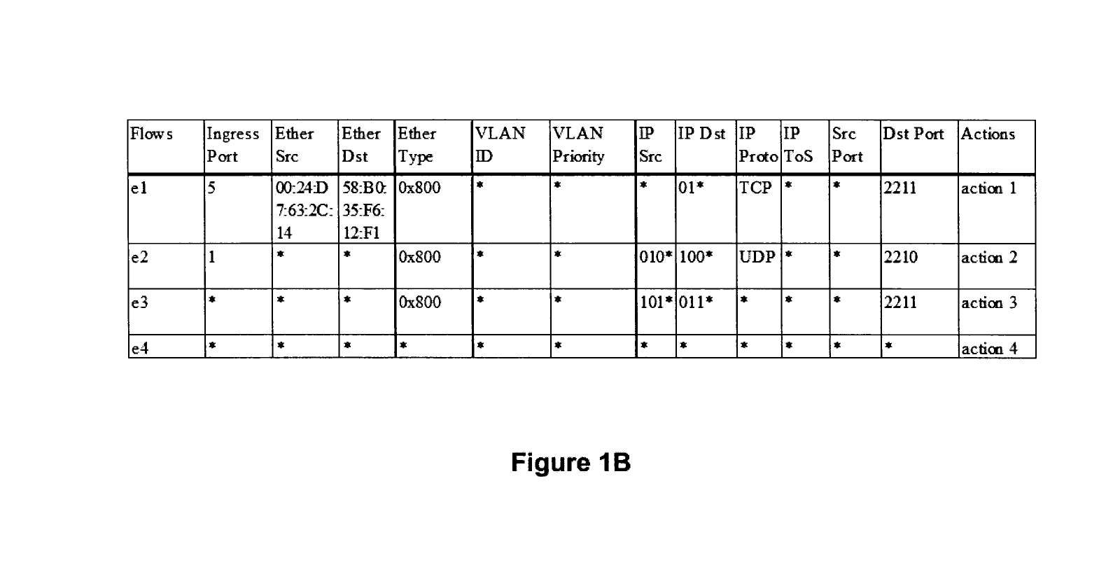

With reference to FIG. 1A, a SDN architecture may comprise a controller component 110, which is a logically centralized control component. The controller component 110 has one or more applications 120 interfacing with it. The SDN also has an infrastructure component 130, comprising an array of programmable switches and/or routers 135. The infrastructure component 130 is also referred to as a data component or an array of forwarding devices. A SDN provides the architectural support to program forwarding devices from a logically centralized, remote control plane, i.e. controller. A SDN also comprises a communication channel 140 between the controller component 110 and the infrastructure component 130. The communication channel 140 is used to communicate bi-directional network state changes between the infrastructure component 130 and the controller component 110.

The communication channel 140 implements a protocol on both sides of the interface between the infrastructure component 130 and the controller component 110. An embodiment of a protocol is the OpenFlow protocol. However, other protocols can be implemented within the communication channel 140, such as the Forces protocol or the OpenFlow Management and Configuration Protocol (OF-Config). Such protocols typically either exchange configuration and forwarding entries between network devices or control software from different vendors. The protocol integrates an enterprise or carrier's existing infrastructure and provides a simple migration path for those segments of the network that need SDN functionality. In an embodiment, the communication channel 140 is implemented by the Transmission Control Protocol (TCP), and the OpenFlow protocol runs on top of TCP. However, other embodiments of the communication channel 140 are contemplated by embodiments of the invention.

The network state in each of the forwarding devices of the infrastructure component 130 is maintained in a flow table, such as the flow table 150 illustrated in FIG. 1A. An alternative form of a flow table is also shown in FIG. 1B. Embodiments are not limited to the examples of flow tables shown herewith, and different types of flow tables are contemplated. The flow table 150 consists of a set of flow entries that determines how each incoming packet should be handled. Each flow entry consists of a combination of network state information. For the flow table 150 illustrated in FIG. 1A, the match field contains header information in each packet that is matched against the set of flow entries. The instructions field determines the set of actions to be applied for each packet. Examples of an instruction field comprise an instruction for an output to an egress port, or to drop the packet. The priority field is used in determining the matching precedence, since a single packet can match multiple flow entries. The counter field updates the counter information for associated counters for every packet that matches a particular flow. In the timeouts field, flows are evicted from the flow table, either by a control message update from the controller or by the flow expiry mechanism. Timeouts are used to determine when a flow is removed from the flow table. The cookie field contains additional information used by the controller to filter flow based information. The flow table 150 illustrated in FIG. 1A is just one example of a network state; embodiments of the invention are not limited to this illustrated network state. Numerous other fields and combinations of fields are contemplated by embodiments of the invention.

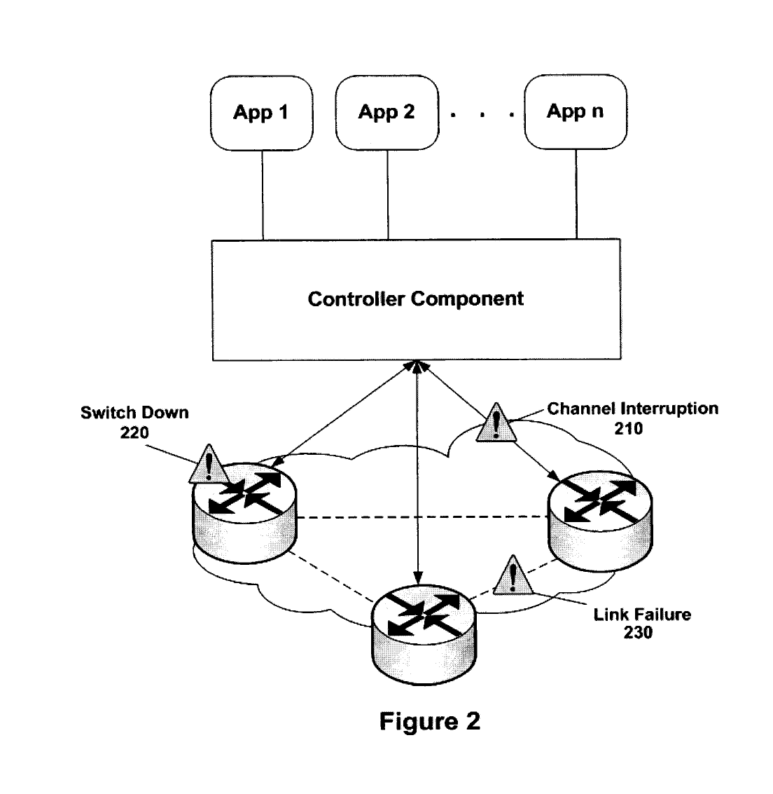

FIG. 2 illustrates the SDN of FIG. 1A in which a channel interruption 210 occurred between the controller component 110 and the infrastructure component 130. The channel interruption 210 may be susceptible to disconnections due to session timeouts, echo request timeouts, or controller and/or hardware issues. When a channel interruption 210 occurs, the network state maintained in the flow table 150 is dependent on the interruption. For example, in fail-secure-mode, the flow entries remain in the switch and expire according to timeouts. When the connection is restored, the controller component 110 can either retain the existing state or delete the network state. If the existing state is retained, the controller component 110 is not aware of the state changes during the channel interruption 210, and therefore, requires polling for the entire state. This usually incurs additional cost in exchanging control messages. If the network state is deleted, the controller component 110 deletes the entire state in the associated switch. This affects data path connectivity, and users will experience downtime until the correct network state is restored.

FIG. 2 also illustrates a switch down event 220. If a programmable switch 135 is down due to hardware issues, the entire network state is lost, which requires re-computation of the entire network state.

FIG. 2 also illustrates a link failure 230 between two programmable switches 135. If there are any changes to an individual component, such as a port or a link failure, the flow table might maintain stale information.

Programmable switches, such as the switches and/or routers 135, enable multiple programming and configuration interfaces that are used to update the network state maintained in the device. Since there are multiple interfaces trying to access the network state, there are more opportunities to introduce violations, misconfigurations, or programming errors, which affect normal forwarding behavior.

There are several challenges or issues to address to maintain uninterrupted service. A consistent pattern or packet flow needs to be checked, in which the underlying set of programmable switches 135 reflect the correct behavior that is intended by the SDN applications and controller logic. Misconfigurations by SDN applications can introduce network instability, such as forwarding loops, black hole problems, or policy violations. In addition, unauthorized permissions should be restricted from modifying the state of certain flow information. For example, a third party application should be restricted from modifying the actions associated with a firewall rule.

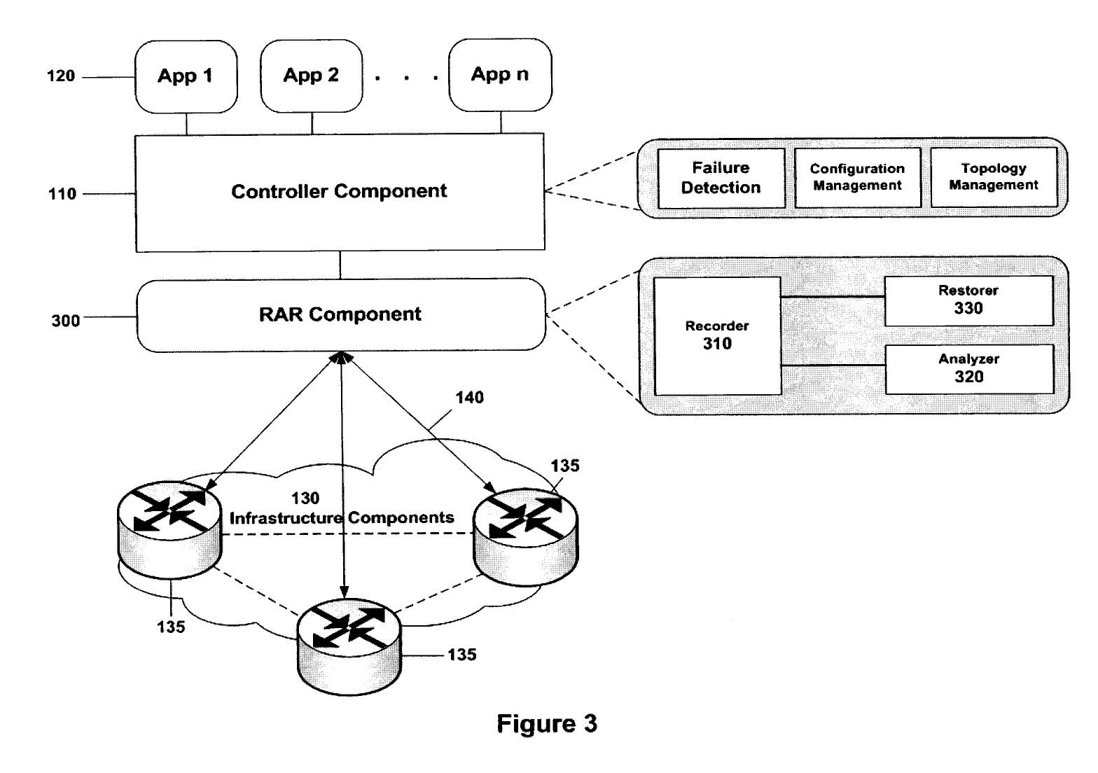

FIG. 3 illustrates the SDN of FIG. 1A with an additional component, referred to herein as a RAR (Recorder, Analyzer, Restorer) component 300. The RAR component 300 comprises a recorder component 310, an analyzer component 320, and a restorer component 330. The recorder component 310 tracks and records bi-directional network state changes between the controller component 110 and the infrastructure component 130. The analyzer component 320 analyzes state changes required to react to failures or misconfigurations, and updates one or more programmable switches 135 to hold consistent network state in the flow table 150. The restorer component 330 ensures recovery of the network state at different granularities. Examples of granularity levels include a single flow entry or set of entries, flows associated with individual network services, and an entire switch state. Embodiments of the invention are not limited to these three granularity levels, and other granularity levels are contemplated by embodiments of the invention.

The RAR component 300 addresses restoration of the network state in programmable switches 135 after an adverse condition arises, such as one of the problems addressed above. Network instability can cause reachability problems, security violations, Denial of Service attacks, misconfigurations, and hardware failures. The RAR component 300 allows network operators to restore the network state to a working state and ensure lower outage times.

The RAR component 300 operates between the controller component 110 and the infrastructure component 130. The RAR component 300 in FIG. 3 is shown as a separate component from the controller component 110 and the infrastructure component 130. An embodiment of the RAR component 300 is hosted in a server as a separate intelligence layer. However, the RAR component 300 could also be part of the controller component 110. The recorder component 310, the analyzer component 320, and the restorer component 330 could operate as separate hardware and/or software components, or could be combined into a single operational hardware and/or software component.

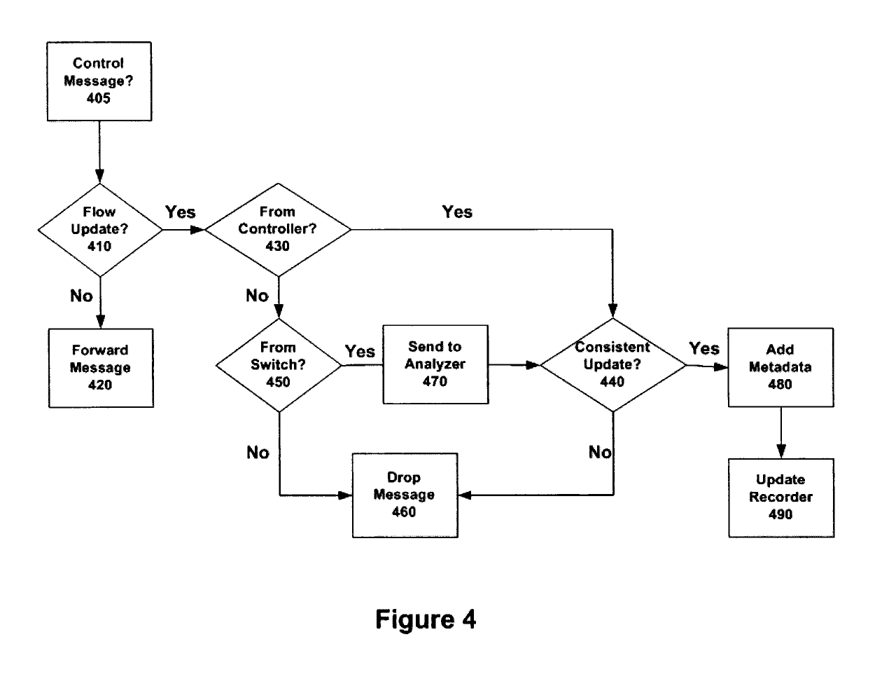

Any flow update (such as add, delete, or modify commands) that is sent to or received from one of the programmable switches 135 is intercepted and recorded by the recorder component 310. The recorder component 310 intercepts all control messages sent within the communication channel 140 between the controller component 110 and the infrastructure component 130. FIG. 4 is a flow algorithm 400 of the recorder component 310 processing. The recorder component 310 determines whether the control message is a flow update in step 410. If the control message is not a flow update, the message is forwarded to its intended recipient in step 420. If the control message is a flow update, the origin of the message is determined. Flow updates can either be sent from the controller component 110 or can be sent from one of the programmable switches 135 as an asynchronous message update.

Step 430 determines whether the flow update is from the controller component 110. If yes, it is determined whether the flow update is a consistent update in step 440. If the flow update is not from the controller component 110, it is determined whether the flow update is from one of the programmable switches 135 in step 450. If the flow update is not from one of the switches 135 (or from the controller component 110), the packet is dropped in step 460. If the control message was received from another entity, the message is considered to be a corrupted update from an unauthorized entity and is dropped. Steps 430 and 450 provide verification of all entities before updating the RAR component 300.

It is determined whether the flow update is from one of the programmable switches 135 in step 450. If the flow update is received from one of the programmable switches 135, it pertains to a change in the existing network state in the flow table 150. The flow update is then sent to the analyzer component 320 in step 470. The analyzer component 320 determines whether the flow update is a consistent update in step 440. Whether or a flow update is consistent is based on whether or not the flow update corresponds to an expected network state according to existing data or an existing policy at the controller component 110. For example, if a flow update conflicts with an existing firewall policy at the controller, then the flow update is an inconsistent update. If the flow update is not consistent with existing data, the message is dropped in step 460. When a flow update from the controller component 110 or from one of the switches 135 is determined to be a consistent update, the flow update is forwarded for addition of metadata in step 480 and updating of the recorder component 310 in step 490.

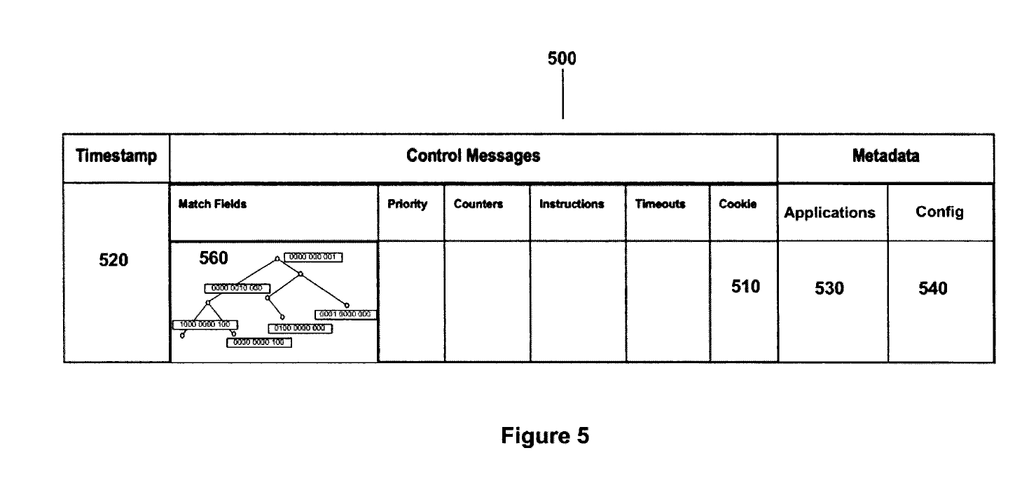

In addition to the fields illustrated in the flow table 150 of FIG. 1A, the recorder component 310 records additional metadata in step 480, which is used for restoration analysis. FIG. 5 illustrates a flow table 500, as used in conjunction with the recorder component 310, in which additional fields are shown. A unique identifier is associated with each flow update. In the programmable switches 135, this can be stored in the cookie field 510, but it is not limited as such and the unique identifier can be stored by using additional metadata and/or timestamps, or the like. When a control message update is received, the recorder component 310 associates a timestamp field 520, indicating when the update was generated. The applications field 530 contains metadata representing the different flows or granularities and gives specific flow information with respect to an application in the applications field 530. A first type of restoration of a network state could be an update for a single flow entry or set of flow entries. The applications field 530 metadata would indicate the type of application included in flow entries for which the first type of restoration would apply. A second type of restoration could be recovering flows associated with individual network services, which would be associated with applications corresponding to the individual network services in the metadata of the applications field 530. A third type of restoration could be recovering an entire switch state. The type of restoration may be provided by an operator input, and the metadata is used to process the inputted request. The first, second, and third restoration applications could also be directly associated with three applications 120, as illustrated atop the controller component 110 in FIGS. 1-3. The configuration field 540 indicates a physical configuration of the network (such as physical path elements in the infrastructure layer) that correspond to the flow entry. When one of the programmable switches 135 fails, metadata in the configuration field 540 can be used to determine the state or configuration of the network that is to be restored. FIG. 5 also shows an illustration of a match field 560 and a flow table that could be used according to embodiments of the invention. However, embodiments of the invention are not limited to these examples. It is also noted that a copy of the flow table may also be stored at the controller in addition to the recorder component (when the RAR component is implemented as a separate entity)

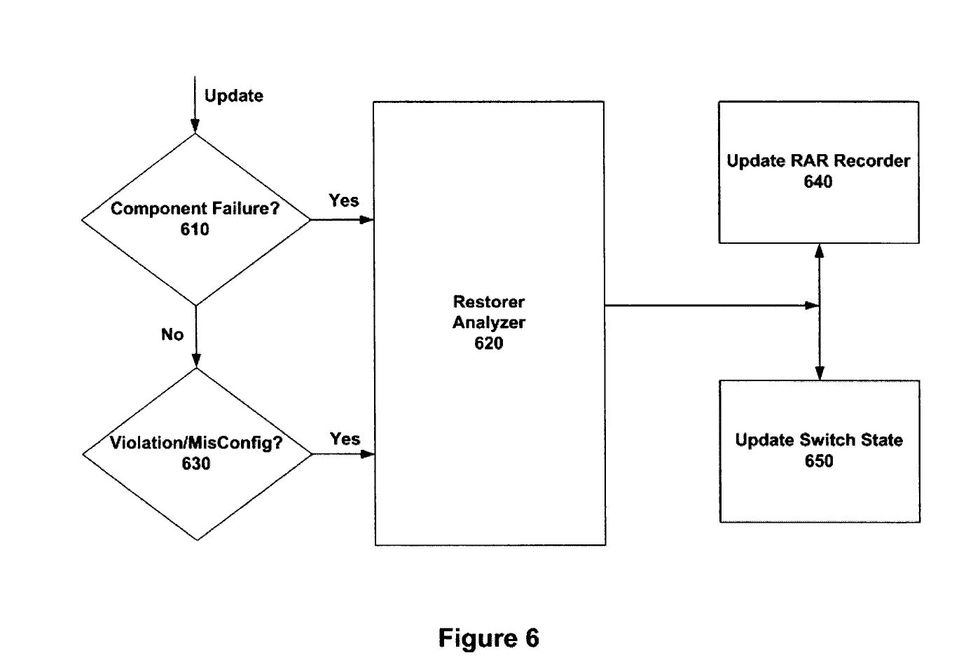

FIG. 6 is a flow diagram 600, illustrating the role or configuration of the analyzer component 320, which analyzes state changes required to react to failures or misconfigurations and updates the switch to hold a consistent network state in the flow table. FIG. 6 also illustrates the restorer component 330, which ensures recovery of network state at different granularities. When an update is received, it is determined whether the update is a component failure in step 610. The “update” shown in FIG. 6 is a notification of some type of change in the network or receipt of new information regarding the network, or a flow update coming from a switch (see step 450 in FIG. 4). If the determination is positive, the update is forwarded to the analyzer and restorer components in step 620. If the update is not a component failure, it is determined whether the update is a violation or misconfiguration in step 630. If the determination is positive, the update is forwarded to the analyzer and restorer components in step 620. After the analyzing and restoring functions are completed, the recorder component 610 is updated in step 640, and the switch state is updated in step 650.

A component failure may arise from several different sources. When a switch component is down, current programmable specification implies that the set of flow entries exists in the switch and will start to expire based on their timeout information. The RAR component 300 has the option of either deleting all existing flow entries, or determining the last updated information at the associated switch and synchronizing the state with the existing state in the recorder component 310. For example, the last updated information at the switch could be a flow remove step or the last update from the controller component 110.

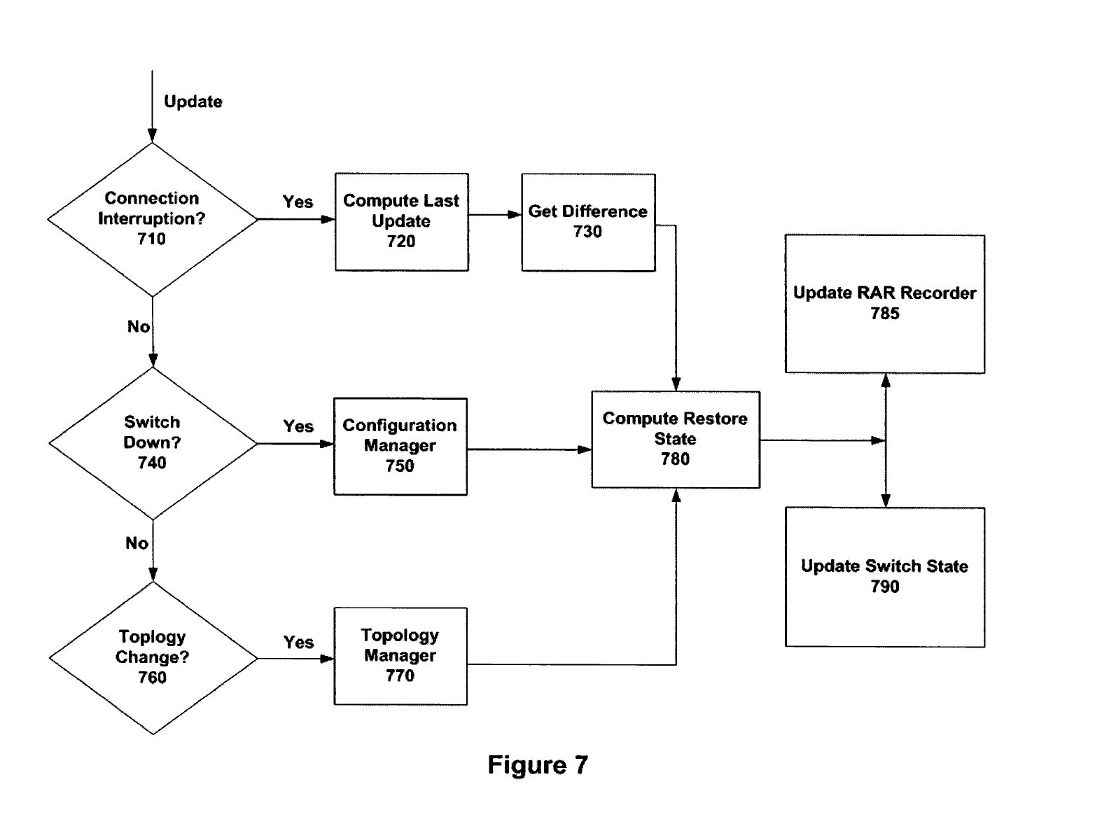

FIG. 7 is a flow algorithm 700 of three different component failures. When an update is received, it is determined whether the update is a connection interruption in step 710. If the determination is positive, the last update is computed in step 720. The difference between the last update and the current update is computed in step 730, calculated in part by using the data in the timestamp field 520 of the RAR component flow table 500. In an embodiment, the difference can be computed using the cache for the associated programmable switch 135.

If the update is not a connection interruption, it is determined whether the flow update is a switch down event in step 740 in FIG. 7. Step 740 determines whether the entire state in the switch is down. Step 740 would also determine one switch at a time, in the event of multiple down switches. If the determination is positive, a configuration manager, which is part of the analyzer component, determines what state to restore in step 750, determined in part by using the metadata in the configuration field 540 of the RAR component flow table 500.

If the update is not a switch down event, it is determined whether the update is a topology change in step 760, with continued reference to FIG. 7. If the determination is positive, a topology manager, which is part of the analyzer component, determines which port or link within the associated switch is down in step 770. A topology manager has a map of the physical programmable switches, which may include the ports to and from the individual switches or groups of switches. The switches have multiple ports or links, and the topology manager knows which port is down. The topology manager would determine how the updates are detected. At the conclusion of steps 730, 750, and 770 for a connection interruption, a switch down, or a topology change, respectively, a restored state is computed in step 780, via the restorer component 330. The recorder component 310 is updated in step 785 and the switch state is updated in step 790, via the analyzer component 320.

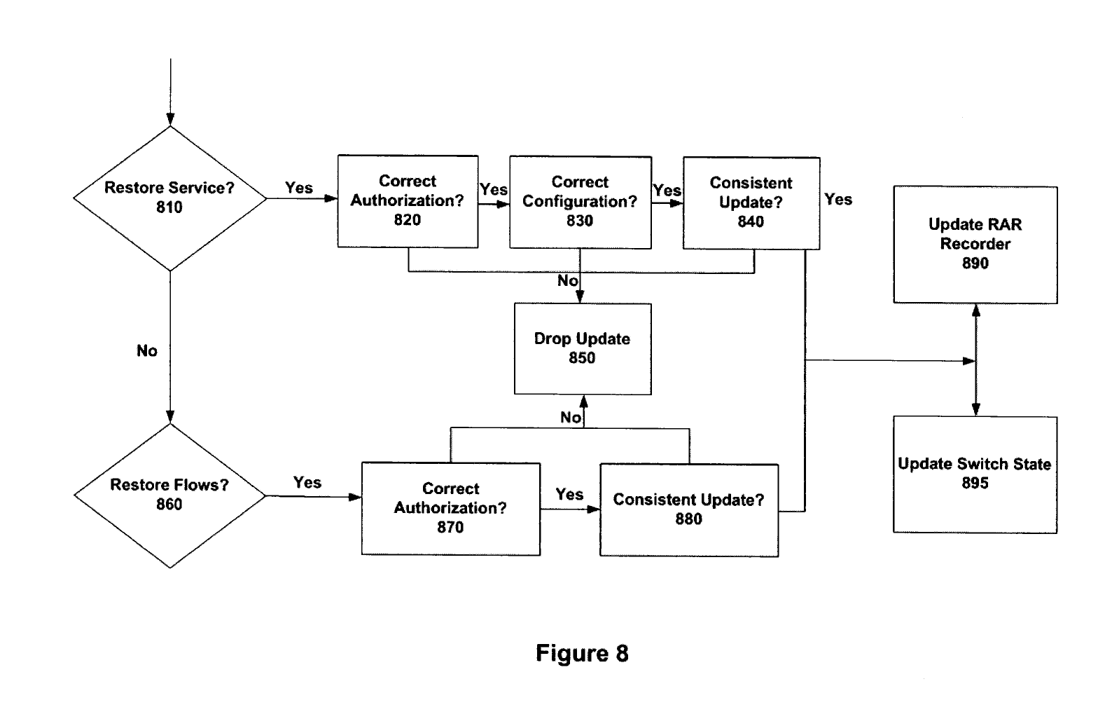

FIG. 8 is a flow algorithm 800 of a logic handler utilized by the restorer component 330 after a failure has been processed by the analyzer component, as illustrated in FIG. 7. When the recorder component 310 has been updated in step 785 and the switch state has been updated in step 790, a determination is made whether or not to restore service in step 810. The determination on whether to restore service can be based on a user input, but it is not limited to this method. For example, there may be a user interface for an operator of the RAR component, by which the operator is viewing a set of flows in the network, and the operator can determine whether to restore service based on the displayed set of flows. If the determination is positive, it is determined wither a correct authorization of the operator exists in step 820. It is also determined whether a correct configuration exists in step 830 (such as the correct configuration of the of the switches in the network and their input and output ports), and whether a consistent update is present in step 840. If the determination of any of steps 820, 830, or 840 is negative, the update is dropped in step 850.

When the determination to restore service in step 810 is negative, a determination is made whether or not to restore individual update flows in step 860, with continued reference to FIG. 8. If the determination is positive, it is determined whether a correct authorization exists in step 870, and whether a consistent update is present in step 880. At the conclusion of steps 840 and 880, the recorder component 310 is updated in step 890, and the switch state is updated in step 895.

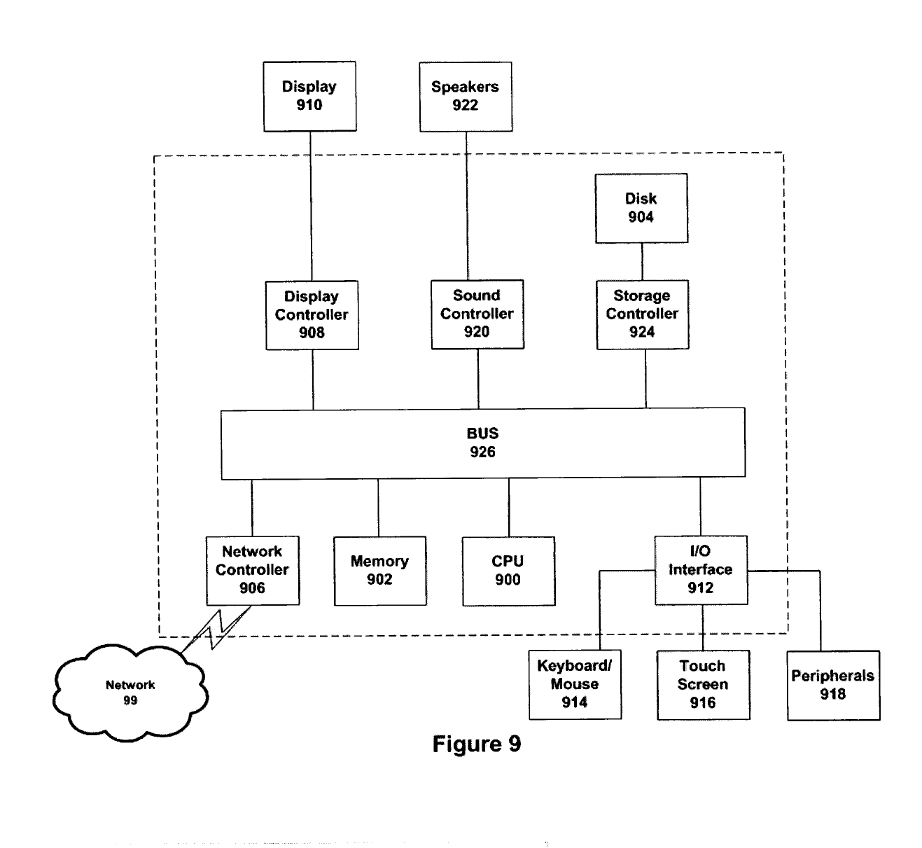

Next, a hardware description of a computing device, used in accordance with exemplary embodiments described herein is described with reference to FIG. 9. In FIG. 9, the computing device includes a CPU 900 which performs the processes described above. The process data and instructions may be stored in memory 902. These processes and instructions may also be stored on a storage medium disk 904 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claimed advancements may be provided as a utility application, background daemon, or component of an operating system, or combination thereof, executing in conjunction with CPU 900 and an operating system such as Microsoft Windows 7, UNIX, Solaris, LINUX, Apple MAC-OS and other systems known to those skilled in the art.

CPU 900 may be a Xenon or Core processor from Intel of America or an Opteron processor from AMD of America, or may be other processor types or circuitry that would be recognized by one of ordinary skill in the art. Alternatively, the CPU 900 may be implemented on an FPGA, ASIC, PLD or using discrete logic circuits, as one of ordinary skill in the art would recognize. Further, CPU 900 may be implemented as multiple processors cooperatively working in parallel to perform the instructions of the inventive processes described above.

The computing device in FIG. 9 also includes a network controller 906, such as an Intel Ethernet PRO network interface card from Intel Corporation of America, for interfacing with network 99. As can be appreciated, the network 99 can be a public network, such as the Internet, or a private network such as an LAN or WAN network, or any combination thereof and can also include PSTN or ISDN sub-networks. The network 99 can also be wired, such as an Ethernet network, or can be wireless such as a cellular network including EDGE, 3G and 4G wireless cellular systems. The wireless network can also be WiFi, Bluetooth, or any other wireless form of communication that is known.

The computing device further includes a display controller 908, such as a NVIDIA GeForce GTX or Quadro graphics adaptor from NVIDIA Corporation of America for interfacing with display 910, such as a Hewlett Packard HPL2445w LCD monitor. A general purpose I/O interface 912 interfaces with a keyboard and/or mouse 914 as well as a touch screen panel 916 on or separate from display 910. General purpose I/O interface also connects to a variety of peripherals 918 including printers and scanners, such as an OfficeJet or DeskJet from Hewlett Packard.

A sound controller 920 is also provided in the computing device, such as Sound Blaster X-Fi Titanium from Creative, to interface with speakers/microphone 922 thereby providing sounds and/or music.

The general purpose storage controller 924 connects the storage medium disk 904 with communication bus 926, which may be an ISA, EISA, VESA, PCI, or similar, for interconnecting all of the components of the computing device. A description of the general features and functionality of the display 910, keyboard and/or mouse 914, as well as the display controller 908, storage controller 924, network controller 906, sound controller 920, and general purpose I/O interface 912 is omitted herein for brevity as these features are known.

FIG. 11 is a flow diagram, illustrating a method 1000 implemented by a system, that includes a recorder component, an analyzer component, and a restorer component. At step 1010, the recorder component records information of a flow table of at least one network device (such as programmable switch or router) in a network by capturing information regarding the flow table that is transmitted to and from the network device. In step 1020, the analyzer component performs analyzes state changes in the network and manages a network state. In step 1030, the restorer component recovers, when a type of failure occurs in the network, the network state by restoring at least a portion of the flow table using the recorded information of the flow table and based on the type of failure event that has occurred.

Embodiments of the invention provide systems and methods to restore the network state of a programmable switch 135. The successful restoration of a correct network state is achieved by recording all flow modification updates, such as ADD, DELETE, MODIFY updates sent from the controller component 110 to the associated programmable switch 135, and analyzing the state to be restored based on the dynamics of network updates. Embodiments of the invention determine a switch failure, and direct what state the network should contain upon restarting. After a security attack or violation, an operator can initiate the restoration process to a secure state in the RAR component flow table 500. When any update is made to the RAR component flow table 500, other than the controller component 110, the RAR component 300 can restore the correct network state.

Numerous modifications and variations of the present invention are possible in light of the above teachings. It is therefore to be understood that within the scope of the appended claims, the invention may be practiced otherwise than as specifically described herein.

What is claimed is:

1. A system comprising:
a recorder that records information of a flow table of at least one network device in a network by capturing information regarding the flow table that is transmitted to and from the network device, wherein the network device receives and forwards incoming packet data over the network, and the flow table is used to determine how each incoming packet is handled by the network device;
an analyzer that analyzes state changes in the network and manages a network state; and
a restorer that, when a type of failure occurs in the network, recovers the network state by restoring at least a portion of the flow table using the recorded information of the flow table and based on the type of failure event that has occurred.

2. The system according to claim 1, wherein the analyzer determines whether an attempted change to the flow table is valid.

3. The system according to claim 1, wherein the analyzer updates one or more of the network devices to hold a consistent network state.

4. The system according to claim 1, wherein the type of failure is a channel interruption between a controller component and the at least one network device, and the restorer recovers the network state based on a difference between a last update to the flow table and a current update to the flow table of the at least one network device.

5. The system according to claim 1, wherein the type of failure is one of a network device being down and a link failure between two of the network devices in the network, and the restorer recovers the network to a predetermined state.

6. The system according to claim 1, wherein the recorder intercepts all control messages sent within a communication channel between a controller component and the at least one network device.

7. The system according to claim 6, wherein the recorder determines whether an intercepted control message is a flow update, and when the control message is a flow update it is determined whether the flow update is from the controller component or the at least one network device, and when the flow update is not from the controller or the at least one network device then the flow update message is dropped.

8. The system according to claim 7, wherein when the flow update is from the network device, the analyzer determines whether the flow update is consistent with the managed network state, and if the flow update is not consistent with the managed network state, the flow update message is dropped, and when the flow update is consistent with the managed network state, the recorder records additional metadata to the flow update which indicates at least one of a type of application and network configuration associated with the flow update.

9. The system according to claim 8, wherein the type of restoration is provided by operator input, the metadata is used to process the input from the operator, and the type of restoration is one of a recovery of a single flow entry or a set of flow entries, recovering flows associated with individual network services, and recovering an entire network device state.

10. The system according to claim 1, wherein the system is located between a controller component and the network device.

11. The system according to claim 1, wherein the system is integrated with a controller component.

12. The system according to claim 1, wherein the restorer recovers the network state to one of a plurality of granularity levels based on the type of failure that has occurred.

13. The system according to claim 12, wherein the granularity levels comprise one or more flow entries, an individual network service, or an entire switch state.

14. The system according to claim 13, wherein each of the granularity levels is associated with an application interfaced with the controller component.

15. The system according to claim 1, wherein the recorder is configured to record one or more of a specific application and a configuration of the network in response to a network state change.

16. A method, implemented by a system that includes a recorder, an analyzer, and a restorer, the method comprising:
recording, by the recorder, information of a flow table of at least one network device in a network by capturing information regarding the flow table that is transmitted to and from the network device, wherein the network device receives and forwards incoming packet data over the network, and the flow table is used to determine how each incoming packet is handled by the network device;
analyzing, by the analyzer, state changes in the network and manages a network state; and
recovering, by the restorer, when a type of failure occurs in the network, the network state by restoring at least a portion of the flow table using the recorded information of the flow table and based on the type of failure event that has occurred.

17. A non-transitory computer-readable medium that stores a program, which when implemented by a computer, causes the computer to perform a method comprising:
recording information of a flow table of at least one network device in a network by capturing information regarding the flow table that is transmitted to and from the network device, wherein the network device receives and forwards incoming packet data over the network, and the flow table is used to determine how each incoming packet is handled by the network device;
analyzing state changes in the network and manages a network state; and
recovering when a type of failure occurs in the network, the network state by restoring at least a portion of the flow table using the recorded information of the flow table and based on the type of failure event that has occurred.
